(19) United States
(12) Patent Application Publication
(10) Pub. No.: US 2024/0248246 A1
(43) Pub. Date: Jul. 25, 2024

(54) Cooking Appliance Light

(71) Applicant: BJB GmbH & Co. KG, Arnsberg (DE)

(72) Inventors: Philipp Henrici, Arnsberg (DE); Olaf Baumeister, Sundern (DE); Katharina Mentler, Frondenberg (DE); Marie Henning, Wickede-Echthausen (DE)

(73) Assignee: BJB GmbH & Co. KG, Arnsberg (DE)

(21) Appl. No.: 18/537,796

(22) Filed: Dec. 12, 2023

(30) Foreign Application Priority Data
Dec. 15, 2022 (DE) 102022133410.4

(51) Int. Cl. F21V 8/00; F24C 15/00; G02B 6/34; B24B 19/22

(52) U.S. Cl. CPC G02B 6/001; F24C 15/008; G02B 6/34; B24B 19/22

(57) ABSTRACT

A cooking appliance light for particular for use in a cooking appliance such as an oven, microwave, or steam cooker, wherein the cooking appliance contains a cooking chamber with walls and a door, which has at least one LED light source that can be secured in a mount outside the cooking chamber, and a fiber optic rod, which extends from the mount along its longitudinal axis at least partially into the cooking chamber, wherein the fiber optic rod has a light entry surface where light from the light source enters the fiber optic rod, and a light emission surface where at least a part of the light is emitted into the interior of the cooking appliance, wherein a decoupling structure that deflects light is formed in the fiber optic rod, with which light is directed through the light emission surface into the interior of the cooking appliance.

The invention relates to a cooking appliance light, in particular for use in an oven, microwave, or steam cooker, which has a cooking chamber with walls and a door, and has at least one LED light source that can be secured outside the cooking chamber in a mount, and a fiber optic rod that extends from the mount at least partially into the cooking chamber, which has a light entry surface where light from the light source enters the fiber optic rod, and a light emission surface where at least part of the light is emitted into the interior of the cooking appliance.

There are numerous lighting devices for cooking appliances in the prior art that have not been documented.

The particularly heat-sensitive LED lamps must be sufficiently protected in cooking appliances, in particular ovens in which high temperatures can be generated. These LED light sources are usually located outside the actual cooking chamber for this reason. The walls of the cooking chamber then contain one or more holes through which a fiber optic rod can pass.

Means with which the cooking chamber can be uniformly lit such that the user can observe the items being cooked have increasingly been given importance in the design of cooking appliance lights.

Not only the placement of the individual components of the lighting device, but also the direction in which the light is focused determine the quality with which the cooking chamber is lit.

DE 10 2011 087 811 A1 discloses a lighting device for the cooking chamber that can be placed in the door, in which the door itself has a reflective coating that reflects the light into the cooking chamber.

Reflective surfaces have also been placed in the cooking chamber where they cannot be seen from the exterior, which reflect the light from the LED light sources into the cooking chamber, as disclosed in DE 10 2016 010 198 A1.

These measures complicate production, however, because the reflective coatings have to be added separately. The materials for this as well as the implementation itself increase production costs.

The object of the invention is to therefore create a better cooking appliance light with which the above disadvantages are eliminated.

This problem is solved by the invention with a cooking appliance light that has the features of claim 1, particularly its characterizing features, according to which a decoupling structure is formed in the fiber optic rod that deflects the light into the interior of the cooking appliance over the length of the light emission surface.

The substantial advantage of the invention is that the decoupling structure formed in the fiber optic rod can be easily and inexpensively produced. This requires none of the additional materials that would otherwise be necessary when applying a coating to a reflective surface. There are also no additional surfaces with which light is reflected. The structuring can be obtained by grinding the surface of the rod to produce a rough finish.

There are numerous ways that these types of fiber optic rods can be used in that the decoupling structure can be adapted to the respective needs. By creating the appropriate decoupling structure, the light can be directed into the cooking chamber in the desired manner.

In a preferred embodiment, the fiber optic rod in the lighting device is made of glass. The ideal types of glass for this are soda-lime glass and borosilicate glass. Glass is particularly ideal because it can withstand high temperatures.

Advantageously, the desired decoupling structure, obtained by grinding the glass for example, can be readily obtained in glass materials. This results in a device that can withstand very high temperatures and continue to produce illumination of high quality. The fiber optic rod can even withstand the temperatures generated by pyrolysis processes that are used for cleaning purposes in many ovens.

In a preferred embodiment of the invention the fiber optic rod is basically round.

A cooking appliance light according to the invention in which the fiber optic rod has a positioning element at the end opposite the light entry surface, with which the fiber optic rod itself, and therefore the light emission surface, can be directed toward the interior of the cooking appliance, is of particular advantage. This positioning element makes it much easier to place the fiber optic rod with precision in the cooking chamber, such that the light emission surface faces the cooking chamber. This also simplifies replacement of a damaged fiber optic rod.

The positioning element is preferably obtained by beveling the fiber optic rod at the end opposite the light entry surface. This beveling results in an angular surface with a slightly rounded tip. The tip can be used as a positioning means by aiming it toward a specific point in the cooking chamber. This can be a mark on the wall in the cooking chamber that the tip is then pointed at. It can also be inserted into a counterpart when positioning the fiber optic rod, such that the tip thereof is held in place. This means that the fiber optic rod can only be placed in one position, such that the decoupling structure is in the optimal position for emitting the light.

Significantly, the beveling is inexpensive to produce. Fiber optic rods are cut to length as needed. This cut can also be made at an angle that is greater than or less than 90° to the longitudinal axis of the fiber optic rod, such that a beveled end is obtained. By selecting the appropriate angle—preferably 42°—the slanted surface can also serve as a reflective surface with which any residual light undergoes a total internal reflection into the cooking chamber, resulting in another special advantage of the design of the cooking appliance light according to the invention.

A decoupling structure obtained by grinding the surface of the glass used in the cooking appliance light over at least a portion of the cladding layer is particularly advantageous. A decoupling structure obtained by grinding, or with an acid treatment to obtain a matte surface, results in a diffused light emitted at the light emission surface on the fiber optic rod treated in this manner.

Use of this type of decoupling structure is advantageous. It can be adapted to different conditions. The decoupling structure can thus be adapted to the placement of the fiber optic rod in the cooking chamber.

If, for example, the fiber optic rod is to be placed in a corner, the grinding can take place on the side facing the cooking chamber, e.g. over 90° of the surface of the fiber optic rod. The ground surface of the fiber optic rod facing the cooking chamber then diffuses the light into the cooking chamber without glare.

The fiber optic rod can also be ground over the entire circumference of the cladding layer if this is advantageous with regard to its placement in the cooking chamber.

In order to obtain a uniform lighting of the cooking chamber, it may be of particular advantage if the decoupling structure in the cooking appliance light according to the invention becomes wider starting from the light entry region, such that it substantially forms a wedge-shaped structure over the length of the fiber optic rod. This results in a grinding of only a small portion of the circumference of the fiber optic rod near the light entry region, which widens over the course of its length. This wedge structure promotes conveyance of the residual light over the length of the fiber optic rod. This results in a more uniform light distribution in the cooking chamber, thus giving the appearance of a more evenly lit interior.

Another advantageous embodiment of the invention is characterized in that the decoupling structure is composed of numerous dome-shaped elements formed by parallel notches cut into the fiber optic rod. This cutting of parallel notches that are transverse to the longitudinal axis of the fiber optic rod represents in an additional advantageous possibility for obtaining a high-quality and uniform light emission over the length of the fiber optic rod by creating a structure for diffusing light. The notches formed in the fiber optic rod are wedge-shaped, thus forming dome-shaped elements between the notches on the surface of the initially round fiber optic rod.

In order to obtain an optimal distribution of the residual light, the spacing between the individual notches decreases over the length of the fiber optic rod starting from the light entry surface, while the depth thereof increases.

In another preferred embodiment of the invention, the fiber optic rod has a substantially rectangular cross section, with two wide and two narrow sides. This is particularly advantageous in some installation situations in a cooking chamber, because it is particularly easy to install it in corners. A decoupling structure can be formed on one of these four longitudinal sides of the fiber optic rod.

This embodiment of the invention is of particular advantage if the decoupling structure is formed one of the wide sides of the fiber optic rod by a row of numerous prism elements. The light entering the fiber optic rod is then reflected numerous times by this structure, such that it is emitted from the fiber optic rod at the side opposite the decoupling structure through the light emission surface. This opposing wide side of the fiber optic rod is preferably formed by a polished light emission surface.

A particularly uniform light emission is obtained with a preferred embodiment in which the individual prism elements are trapezoidal, placed such that the shorter parallel side of the trapezoid is at the same height as a wide longitudinal side of the fiber optic rod, and the lateral surfaces of each prism element are at an angle ϑ to those of the adjacent prism elements, where ϑ is preferably between 38° and 60°.

An embodiment in which the individual angles 9 between the slanted sides of adjacent prism elements decrease over the length of the fiber optic rod starting from the light entry surface is also preferrable. This results in a total reflection of the residual light in the fiber optic rod, such that any residual light is then emitted into the cooking chamber at the end of the fiber optic rod opposite the light entry surface.

This effect is further improved if the height h of the trapezoidal prism elements continuously decreases over the length of the fiber optic rod starting from the light entry surface.

Further advantages and a better understanding of the invention can be derived from the following descriptions of exemplary embodiments. Therein:

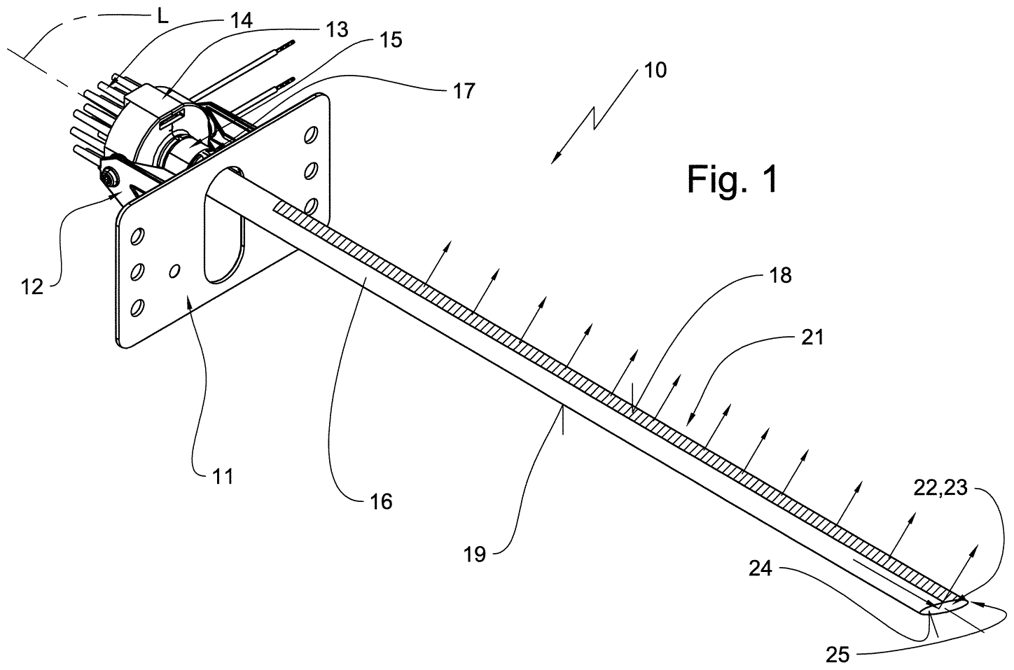

FIG. 1 shows a perspective view of a first embodiment of the cooking appliance light according to the invention;

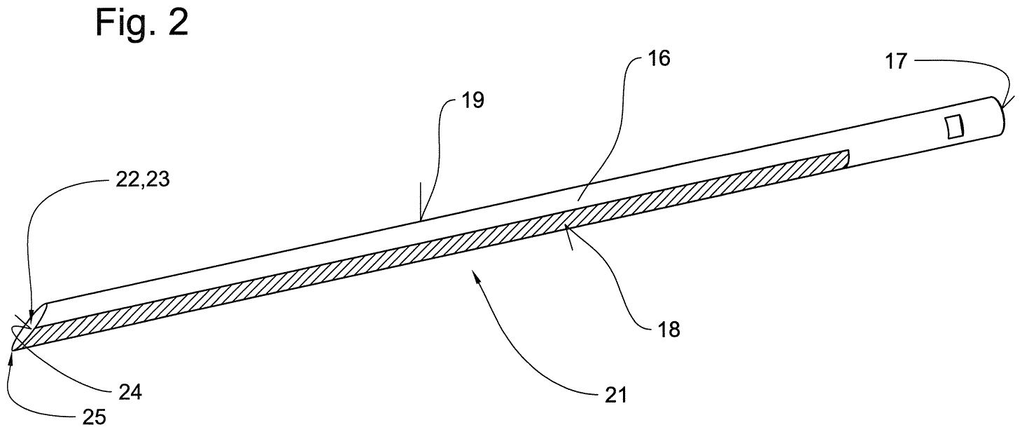

FIG. 2 shows a first possible embodiment of the decoupling structure on a rod-shaped fiber optic rod in the cooking appliance light according to the invention shown in FIG. 1;

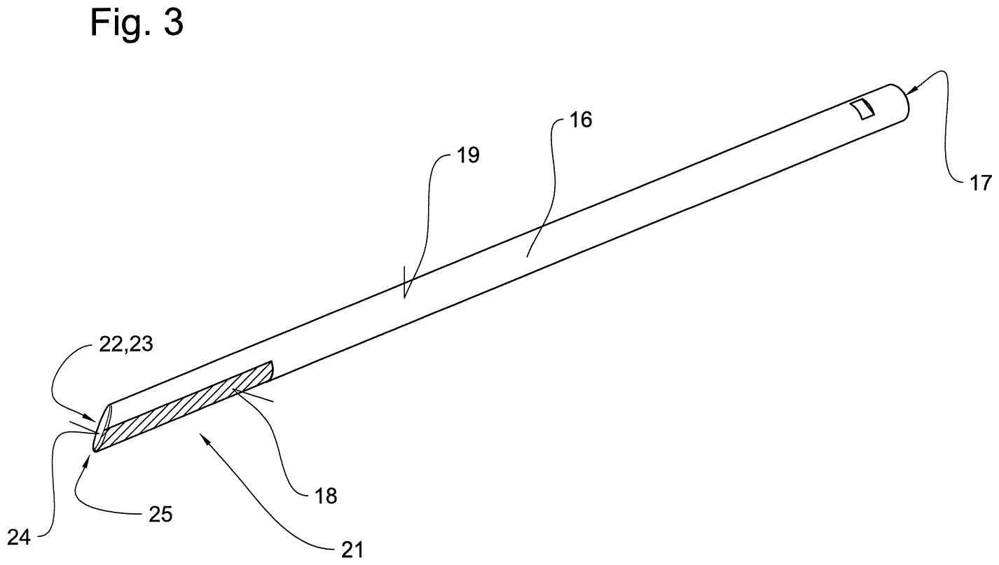

FIG. 3 shows a second possible embodiment of the decoupling structure on a rod-shaped fiber optic rod in the cooking appliance light according to the invention shown in FIG. 1;

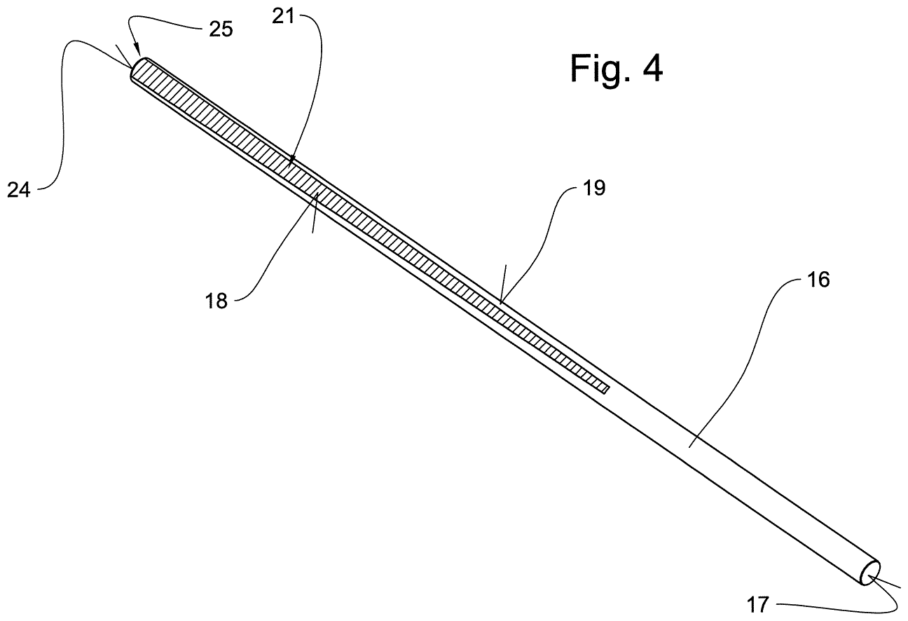

FIG. 4 shows a third possible embodiment of the decoupling structure on a rod-shaped fiber optic rod in the cooking appliance light according to the invention shown in FIG. 1;

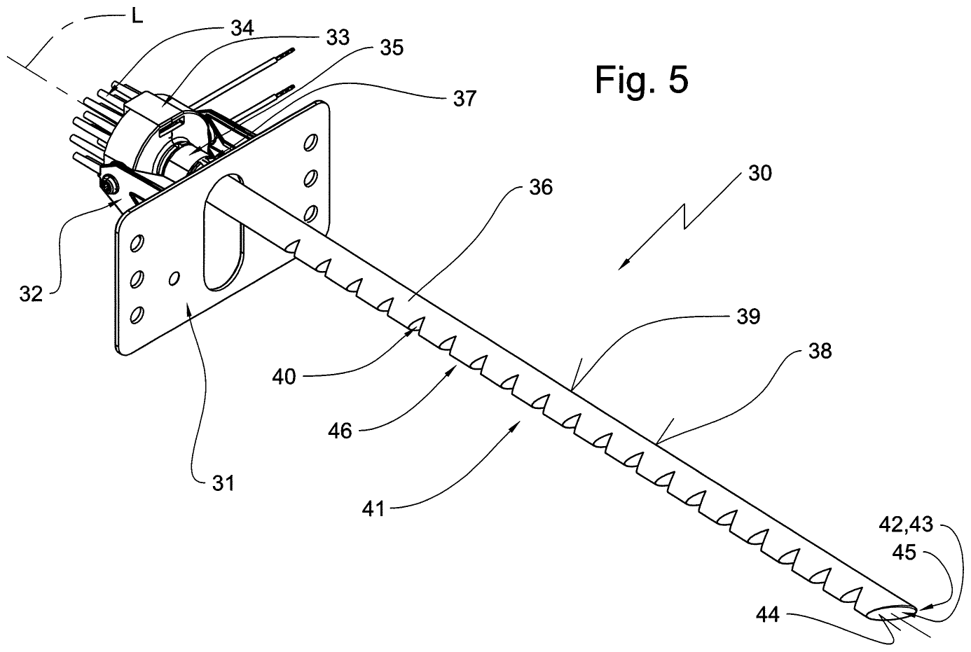

FIG. 5 shows a perspective view of a second embodiment of the cooking appliance light according to the invention;

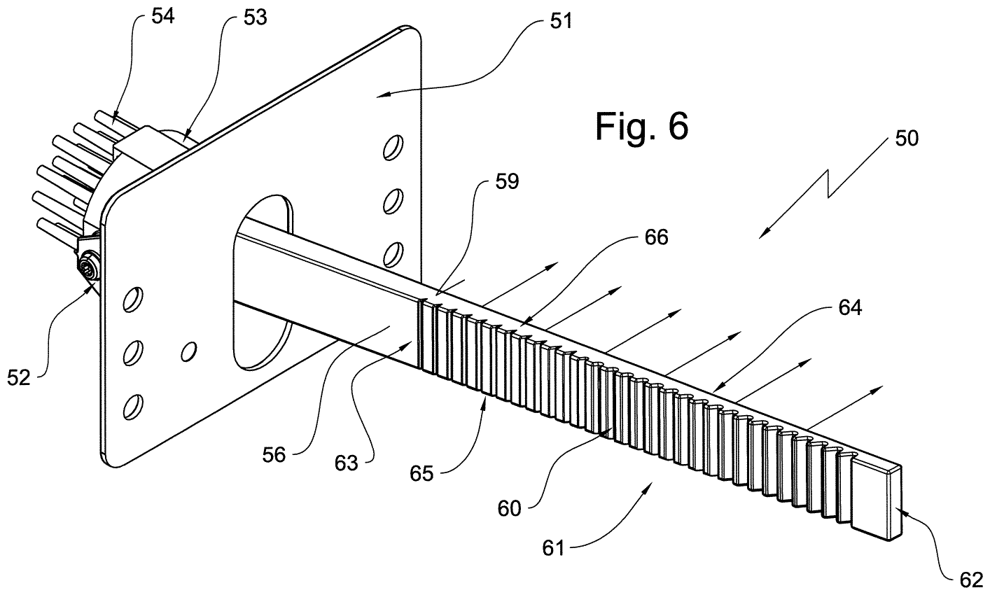

FIG. 6 shows a perspective view of a third embodiment of the cooking appliance light according to the invention;

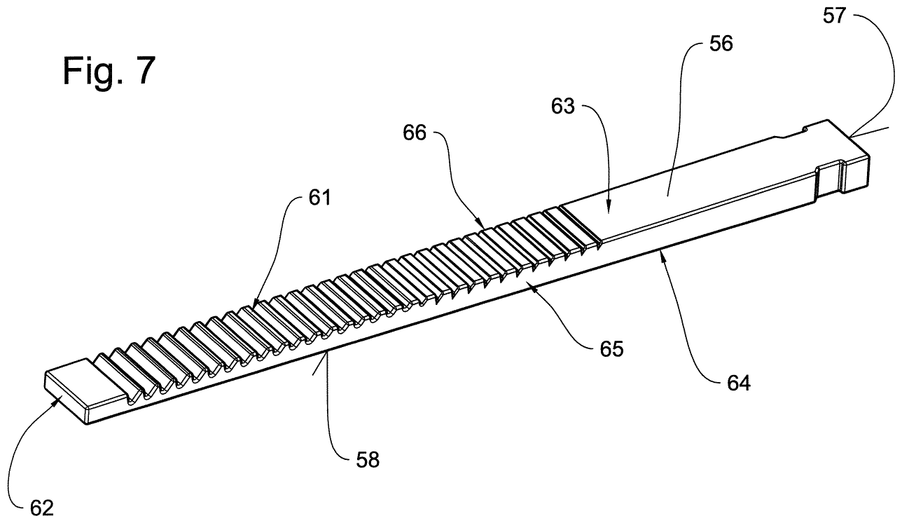

FIG. 7 shows a perspective view of the fiber optic rod for the cooking appliance light shown in FIG. 6;

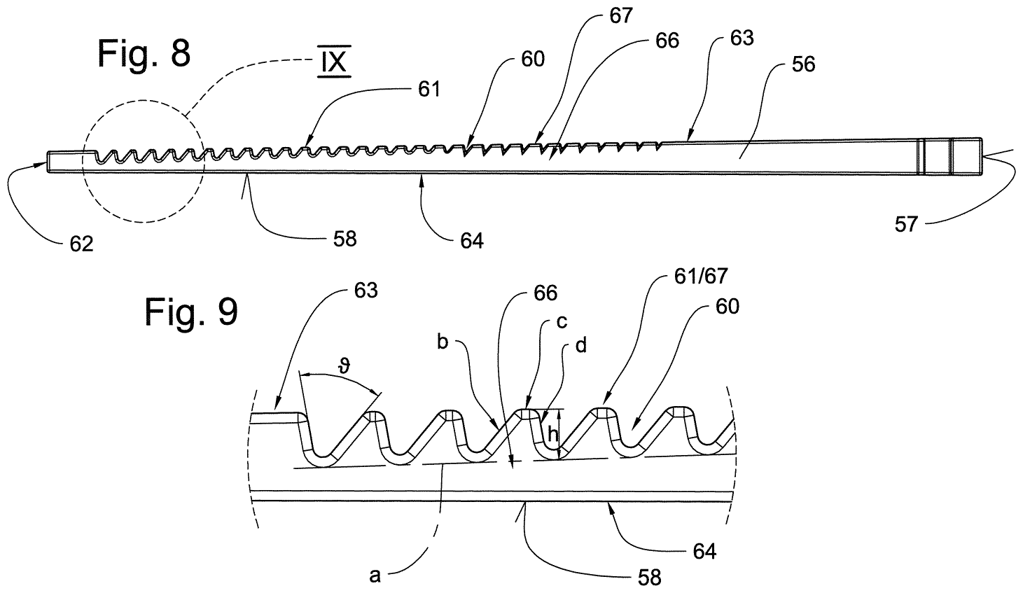

FIG. 8 shows a side view of the fiber optic rod for the cooking appliance light shown in FIG. 6; and

FIG. 9 shows a detail from FIG. 8, with an enlarged view of the prism elements on the fiber optic rod for the cooking appliance light shown in FIG. 6.

The cooking appliance light as a whole, also simply referred to as a light below, is given the reference numeral 10, 30, or 50 in the drawings.

A first embodiment of the cooking appliance light according to the invention is shown in FIG. 1. It has the reference numeral 10. The cooking appliance light 10 comprises a mounting plate 11 with which it can be attached to the inside of a cooking appliance. The mounting plate 11 has two retaining arms 12 that support a bracket 13 containing a heat sink 14, and a printed circuit board with an LED thereon, not shown in detail. The heat sink 14 discharges heat generated by the LED.

A receiver is formed on the side of the bracket 13 facing the mounting plate 11. In FIG. 1, this receiver is round, corresponding to the shape of the fiber optic rod 16. A fiber optic rod, or optical fiber 16, can be placed in the receiver 15. The fiber optic rod is made of a solid material. This material can be heat resistant plastic, or preferably glass.

Glass—in particular borosilicate glass or soda-lime glass—is particularly ideal for use in cooking appliances where high temperatures may be generated. This results in a durable and function fiber optic rod 16 where it extends into the cooking chamber, even at high temperatures, e.g. during cleaning processes involving pyrolysis.

The end of the fiber optic rod 16 facing the LED and printed circuit board placed in the receiver 15 forms a light entry surface 17. The LED on a printed circuit board in the bracket 13 directs its light through this surface into the fiber optic rod 16. A collar on the bracket and/or retaining element (e.g. a supporting element), which is not shown, prevents light from exiting at this point.

The fiber optic rod 16 extends from the receiver 15 and the mounting plate 11 along its longitudinal axis L into the cooking chamber. It can extend partially or entirely into the cooking chamber. In particular, fiber optic rods made of glass can also withstand high temperatures, and can also be placed in the cooking chamber itself.

The fiber optic rod 16 is round. It has a cladding layer 19. A decoupling structure 21 that extends axially along the fiber optic rod 16 is formed in this cladding layer 19. This also forms the light emission surface 18 in the present example, through which the light is emitted into the cooking chamber.

This decoupling structure 21 is shaded in FIG. 2. This can be a ground or acid-treated surface to produce a rough or matte surface. The decoupling structure 21 is formed in the fiber optic rod 16 according to the invention by structuring the outer surface of fiber optic rod material itself. The ground surface, for example, then diffuses the light coupled in the optical fiber 16 into the cooking chamber. This is indicated schematically by arrows in FIG. 1.

Reflective coatings, which are difficult to apply, and can become damaged at high temperatures, are not needed with the lighting device 10 according to the invention.

The surface of a fiber optic rod can be structured according to a customer's requirements, or for specific uses, to obtain a decoupling structure 21. The light deflection can be affected by the selected structure, its orientation, and its dimensions on the fiber optic rod.

FIG. 2 shows a rod-shaped optical fiber 16 that has been ground over nearly the entire length of the fiber optic rod 16, which covers approximately a quarter, i.e. 90° of the cladding layer 19 of the fiber optic rod 16. This fiber optic rod is ideal for placement in a corner of an oven interior, i.e. where two panels of the walls of the oven meet. The ground surface of the fiber optic rod 16 is then placed such that it faces the cooking chamber, in order to obtain a uniform illumination thereof.

FIG. 3 shows another variation of the first embodiment of the invention in which only the lower end 22 of the fiber optic rod 16, away from the light entry surface 17, has been ground. This embodiment is ideal for use with a reflector (not shown). The ground area is then oriented toward an additional reflective surface to obtain the desired lighting in the cooking chamber.

FIG. 4 shows a third advantageous variation in which the decoupling structure 21 extends in the shape of a wedge along the longitudinal axis L of the optical fiber 16. This decoupling structure 21 is of particular advantage for obtaining the most uniform distribution of the light.

The beveling 23 of the fiber optic rod 16 shown in FIGS. 1 to 4 is of particular advantage for the lighting device according to the invention. The free end 22 of the fiber optic rod 16 has not be cut at a right angle to the longitudinal axis L of the fiber optic rod 16, but instead has been cut at an angle.

The polished surface of the beveling 23 forms a reflective surface 24 that ensures that any residual light in the fiber optic rod 16 near the free end is still emitted through total internal reflection into the cooking chamber.

The beveling 23 also forms a rounded tip 25 at the free end that is used as a positioning element. The tip 25 can be pointed at a counterpoint, e.g. a mark. This enables a precision alignment of the fiber optic rod 16 in the cooking chamber. This also results in a precision alignment of the decoupling structure 21 and therefore the light emission surface 18 of the fiber optic rod 16 in the cooking chamber.

FIG. 5 shows a second embodiment of the cooking appliance light according to the invention. This is indicated with the reference numeral 30. As with the embodiment shown in FIG. 1, this cooking appliance light 30 comprises a mounting plate 31 with retaining arms 32, and a bracket 33. The bracket 33 contains a heat sink 34 that is used to cool the printed circuit board for the cooking appliance light 30 with the LED thereon, not shown in detail.

The fiber optic rod 36 in this second embodiment is supported in a receiver 35 at the end forming the light entry surface 37, in the same way the fiber optic rod 16 is held in the receiver 15. This fiber optic rod 36 is also made of a solid material (preferably glass), with a substantially round cross section.

The fiber optic rod 36 extends from the receiver 36 and mounting plate 31 along its longitudinal axis L into the cooking chamber. It can extend partially or entirely into the cooking chamber.

The round fiber optic rod has a cladding layer 39. This cladding layer 39 also has an axial decoupling structure 41 formed in the fiber optic rod 36. The decoupling structure 41 comprises numerous notches 40 cut into the glass rod. All of the notches 40 are parallel to one another. The notches 40 are perpendicular to the longitudinal axis L of the fiber optic rod 36. Starting at the light entry surface 37, the depth of the notches 40 increases toward the free end 42 of the fiber optic rod 36.

The cutting of the notches 40 leaves dome-shaped elements 46. The light entering the fiber optic rod 36 at the light entry surface 37 is reflected multiple times in the dome-shaped elements 46 formed by the notches 40 and then emitted from the fiber optic rod through the light emission surface 38 opposite the dome-shaped elements 46 into the cooking chamber.

Like the first embodiment, the second embodiment of the invention also has a beveling 43 at the free end 42 of the fiber optic rod 36. The beveling 43 also forms a polished reflective surface 44 in this case, which ensures that the remaining light in the free end 42 is fully emitted into the cooking chamber.

The beveling 43 forms a rounded tip 46 at the free end 42 that acts as a positioning element. The tip 45 can also be pointed at a counterpoint, e.g. a mark, in this embodiment as well. This allows for a precision alignment of the fiber optic rod 36 in the cooking chamber. The tip 46 forms the end of the light emission surface 38 on the free end 42 of the fiber optic rod 36. The beveling is also optimally aligned for emitting any residual light through total internal reflection at the end of the fiber optic rod 36.

FIG. 6 shows a third advantageous embodiment of the cooking appliance light 50 according to the invention. This also comprises a mounting plate 51 for the device in the interior of the cooking appliance. The mounting plate 51 also has two retaining arms 52 with a bracket 53 therebetween. There is a heat sink 54 on the bracket 53, and a printed circuit board with an LED, not shown in detail.

The fiber optic rod 56 used in this embodiment of the cooking appliance light 50 according to the invention has a rectangular cross section, as can be seen in particular in FIG. 7. The fiber optic rod receiver 55 that fits into the bracket 53 is shaped to fit the rectangular cross section of the fiber optic rod.

This fiber optic rod 56 is also made of a solid material, preferably glass. The rectangular cross section, which tapers toward the free end 62, has two wider sides (63, 64) and two narrower sides (65, 66).

The use of this fiber optic rod 56 has numerous advantages. In simple terms, it has an angular design. Consequently, it is much easier to fit it into certain positions in the cooking chamber than a round fiber optic rod. Emission of the light at one of the wider sides results in a better lighting of the cooking chamber. Because it is made of glass, it can withstand high temperatures. Because no additional coatings have to be applied, and instead the reflective structures in the form of prisms are formed directly in the optical fiber, even the typical pyrolysis procedures used in modern ovens are not a problem. The fiber optic rod can therefore be placed and aligned anywhere in the cooking chamber. At the same time, it is extremely sturdy, which can be seen as a further advantage when the fiber optic rod extends nearly entirely into the cooking chamber, in which the food that is to be cooked is placed on a rack or baking sheet.

One of the wider sides 63 has a decoupling structure 61 formed in the side 63 of the fiber optic rod 56. It comprises numerous prism elements 67 formed in the material of the fiber optic rod 56. These are formed by making notches 60 in the wide side 63. The light entering the fiber optic rod 56 through the light entry surface 57 strikes the individual prism elements 67 as it passes through the fiber optic rod and is reflected by the lateral surfaces formed by the notches, and emitted from the fiber optic rod at the opposite, polished, flat side 64, which forms the light emission surface 58. This is indicated schematically in FIG. 6 by arrows.

As can be seen in FIGS. 7 to 9, in particular in the enlarged detail shown in FIG. 9, the decoupling structure 61 comprises prism elements 67 that differ from one another.

These are obtained by notches 60 that become closer together and deeper as they approach the free end 62 of the fiber optic rod 56 on the side 63 thereof.

Each prism element 67 is trapezoidal. Each trapezoid has two parallel sides a and c and two legs b and d that are slanted. The shorter of the parallel sides c is at the same height as the longitudinal surface 63, such that all of the prisms have the same alignment. The parallel sides c form the longitudinal surface here. This results in adjacent legs of the trapezoids, and thus the lateral surfaces of the adjacent prisms, that are at an angle ϑ to one another. This angle ϑ is preferably between 38° and 60°.

FIG. 8 shows that the height h of the individual trapezoids of each prism element 67 increases from the light entry surface 57 of the fiber optic rod 56 to its free end 62. In other words, the depth of the notches 60 in the fiber optic rod increases from the light entry surface 57 to the free end 62 to obtain the prism elements 67 formed therein.

On the whole, this prism structure results in a deflection of the light beams entering the fiber optic rod 56 such that the light is emitted entirely through the side 64 of the fiber optic rod opposite the prism elements 67, which forms the light emission surface 58. This results in a uniform lighting of the cooking chamber in the cooking appliance.

### LIST OF REFERENCE SYMBOLS

10 cooking appliance light
11 mounting plate
12 retaining arms
13 bracket
14 heat sink
15 receiver
16 fiber optic rod
17 light entry surface
18 light emission surface
19 cladding layer
21 decoupling structure
22 free end
23 beveling
24 reflective surface
26 positioning element
30 cooking appliance light
31 mounting plate
32 retaining arms
33 bracket
34 heat sink
35 receiver
36 fiber optic rod
37 light entry surface
38 light emission surface
39 cladding layer
40 notch
41 decoupling structure
42 free end
43 beveling
44 reflective surface
45 positioning element
46 dome-shaped elements
50 cooking appliance light
51 mounting plate
52 retaining arm
53 bracket
54 heat sink
55 receiver
56 fiber optic rod
57 light entry surface
58 light emission surface
59 cladding layer
60 notch
61 decoupling structure
62 free end
63 wide longitudinal surface with notches and prism elements
64 wide longitudinal surface
65 narrow longitudinal surface
66 narrow longitudinal surface
67 prism element
a long parallel side of a trapezoid forming 67
c short parallel side of a trapezoid forming 67
b, d legs of the trapezoid forming 67
h height of the trapezoid forming 67
L longitudinal axis of the fiber optic rod 16, 36, 56

1. A cooking appliance light (10, 30, 50), in particular for use in an oven, microwave, or steam cooker, wherein the cooking appliance comprises a cooking chamber with walls and a door, which has at least one LED light source that can be secured in a mount (13, 33, 53) outside the cooking chamber, and a fiber optic rod (16, 36, 53), which extends from the mount (13, 33, 53) along its longitudinal axis at least partially into the cooking chamber, wherein the fiber optic rod (16, 36, 56) has a light entry surface (17, 37, 57) where light from the light source enters the fiber optic rod (16, 36, 56), and a light emission surface (18, 38, 58) where at least a part of the light is emitted into the interior of the cooking appliance, wherein a decoupling structure (21, 41, 61) that deflects light is formed in the fiber optic rod (16, 36, 56), with which light is directed through the light emission surface (18, 38, 58) into the interior of the cooking appliance.

2. The cooking appliance light (10, 30, 50) according to claim 1, wherein the fiber optic rod (16, 36, 56) is made of glass.

3. The cooking appliance light (10, 30) according to claim 2, wherein the fiber optic rod (16, 36) is substantially round.

4. The cooking appliance light (10, 30) according to claim 3, wherein the fiber optic rod (16, 36) comprises a positioning element (25, 45) on the end opposite the light entry surface (17, 37) with which the fiber optic rod (16, 36), and therefore the light emission surface (18, 38) can be pointed toward the interior of the cooking appliance.

5. The cooking appliance light (10, 30) according to claim 4, wherein the fiber optic rod (16, 36) has a beveled end (22, 23, 42, 43) that forms the positioning element (25, 45).

6. The cooking appliance light (10) according to claim 1, wherein the decoupling structure (21) is formed by grinding at least part of the cladding layer (19) of the fiber optic rod (16) to produce a rough surface.

7. The cooking appliance light (10) according to claim 6, wherein the decoupling structure (21) extends over 90° of the cladding layer (19) of the fiber optic rod (16).

8. The cooking appliance light (10) according to claim 6, wherein the decoupling structure (21) becomes wider starting from the light entry surface (17), such that it is substantially in the form of a wedge over the length of the fiber optic rod (16).

9. The cooking appliance light (30) according to claim 1, characterized in that claim 1, wherein the decoupling structure (41) is composed of numerous dome-shaped elements (46), formed by parallel wedge-shaped notches (40) in the fiber optic rod (36).

10. The cooking appliance light (30) according to claim 9, wherein the spacing between the notches (40) decreases over the length of the fiber optic rod (36) starting from the light entry surface (37), while the depth increases.

11. The cooking appliance light (50) according to claim 2, wherein the fiber optic rod (56) has a substantially rectangular cross section, wherein it has two wide and two narrow sides (63, 64, 65, 66), and the decoupling structure (61) in the form of numerous prism elements (67) is formed on one of the wide sides (63) of the fiber optic rod (56), which are formed by wedge-shaped parallel notches (60) in the wide side (63) of the fiber optic rod (56).

12. The cooking appliance light (50) according to claim 11, wherein the individual prism elements (67) are trapezoidal, placed such that the shorter parallel side (c) of the trapezoid is at the height of the wide side (63) of the fiber optic rod (56), and the lateral surfaces of each prism element (67) are each at an angle (ϑ) to those of the adjacent prism element (67), wherein the angle (ϑ) is preferably between 38° and 60°.

13. The cooking appliance light (50) according to claim 12, wherein the individual angles (ϑ) between adjacent prism elements (67) become smaller over the length of the fiber optic rod (56) starting from the light entry surface, and the depth of the notches (60) increases.

14. The cooking appliance light (10) according to claim 2, wherein the decoupling structure (21) is formed by grinding at least part of the cladding layer (19) of the fiber optic rod (16) to produce a rough surface.

15. The cooking appliance light (10) according to claim 3, wherein the decoupling structure (21) is formed by grinding at least part of the cladding layer (19) of the fiber optic rod (16) to produce a rough surface.

16. The cooking appliance light (10) according to claim 4, wherein the decoupling structure (21) is formed by grinding at least part of the cladding layer (19) of the fiber optic rod (16) to produce a rough surface.

17. The cooking appliance light (10) according to claim 5, wherein the decoupling structure (21) is formed by grinding at least part of the cladding layer (19) of the fiber optic rod (16) to produce a rough surface.

18. The cooking appliance light (30) according to claim 2, wherein the decoupling structure (41) is composed of numerous dome-shaped elements (46), formed by parallel wedge-shaped notches (40) in the fiber optic rod (36).

19. The cooking appliance light (30) according to claim 3, wherein the decoupling structure (41) is composed of numerous dome-shaped elements (46), formed by parallel wedge-shaped notches (40) in the fiber optic rod (36).

20. The cooking appliance light (30) according to claim 8, wherein the decoupling structure (41) is composed of numerous dome-shaped elements (46), formed by parallel wedge-shaped notches (40) in the fiber optic rod (36).
